(19) United States
(12) Patent Application Publication
(10) Pub. No.: US 2026/0366624 A1
(43) Pub. Date: Nov. 19, 2026

(54) VALVE

(71) Applicant: Fujikiin Incorporated, Osaka-shi, Osaka (JP)

(72) Inventors: Tomohiro Mouri, Osaka (JP); Koji Hiramatsu, Osaka (JP); Tomoya Kanzaki, Osaka (JP)

(73) Assignee: Fujikin Incorporated, Osaka-shi, Osaka (JP)

(21) Appl. No.: 19/133,932

(22) PCT Filed: Aug. 29, 2023
(86) PCT No.: PCT/JP2023/031082

§ 371 Date: May 29, 2025

(30) Foreign Application Priority Data
Nov. 30, 2022 (JP) JP2022-191913

(51) Int. Cl. F16K 1/42

(52) U.S. Cl. CPC F16K 1/422

(57) ABSTRACT

A valve for reducing the risk of leakage between a seat member and a valve main body when a high-temperature and high-pressure fluid is passed includes: a main body 10 having a valve chamber 13 communicably connecting an inlet passage 11 and an outlet passage 12; a seat member 30 that has a cylindrical shape, and that includes an inlet-side passage 32 communicably connected to the inlet passage, an outlet-side passage 33 communicably connected to the outlet passage, and a valve seat 31 provided to a periphery of an opening of the outlet-side passage, and disposed inside the valve chamber; and a valve body 4 that comes into abutment against, and separates from, the valve seat, in which a male taper 35 is provided to a valve seat-side end of the seat member, and the male taper presses a female taper 16 provided to the valve chamber to provide sealing.

### TECHNICAL FIELD

The present invention relates to a valve for controlling a fluid, and more particularly to a valve suitably used as an on-off valve for controlling a high-pressure fluid.

### BACKGROUND ART

The valve for a high-pressure fluid described in Patent Literature 1 includes, as illustrated in FIG. 5(1), a valve main body 101 having a valve chamber 104 communicably connecting a fluid inlet 102 and a fluid outlet 103. Provided inside the valve chamber 104 is a seat member 106 including a valve seat 107 for controlling the fluid by coming into abutment against and separating from a valve body 114. The seat member 106 is pressed upward from below, by a pressing member 109 that is screwed into the valve main body 101. Leakage of the fluid from the upper end of the seat member 106 is thus prevented.

FIG. 5(2) is an enlarged view of a part of FIG. 5(1). The description of the elements described with reference to FIG. 5(1) will be partly omitted. The fluid flows into an inlet passage 102a via the fluid inlet 102, passes through an inlet-side communicating passage 106a and an outlet-side communicating passage 106b provided inside the seat member 106, passes through an outlet passage 103a, and flows out through the fluid outlet 103.

### CITATION LIST

### Patent Literature

Patent Literature 1: WO2019/026814 A

### SUMMARY OF INVENTION

### Technical Problem

However, not only when the pressure of the fluid passed through the valve is to be further increased significantly, but also when the temperature as well as the pressure of the fluid are high, there is a concern that the screw may loosen, and the surface pressure between the seat member and the valve main body may drop, and cause a leakage of the fluid from a seat member abutting surface.

An object of the present invention has been made in view of the issue described above, and is to provide a valve for reducing the risk of leakage between a seat member and a valve main body when a high-temperature and high-pressure fluid is to be passed.

### Solution to Problem

A present invention (1) made to address the issue described above provides a valve including: a valve main body that includes a valve chamber communicably connecting an inlet passage and an outlet passage for a fluid; a seat member that has a cylindrical shape, and that includes an inlet-side communicating passage communicably connected to the inlet passage, an outlet-side communicating passage communicably connected to the outlet passage, and a valve seat provided to a periphery of an opening of the outlet-side communicating passage, and that is disposed inside the valve chamber; and a valve body that comes into abutment against and separates from the valve seat, in which a male taper is provided to a valve seat-side end of the seat member, and the male taper presses a female taper provided to the valve chamber to provide sealing.

In the present invention (1), the outer periphery of the seat member is provided with the male taper that is tapered on the side of the valve seat; the valve chamber is provided with the female taper to be taper-fitted with the male taper; and the seat member and the valve main body are taper-fitted to each other. Therefore, even if a force reducing the fitting force acts on the seat member, because the frictional force exerts on the slope of taper, the force reducing the fitting force becomes smaller by the sine of the taper angle. Hence, reduced sealability between the seat member and the valve main body becomes less of a concern. This will be described later in detail, in the explanation of FIG. 4.

A present invention (2) is the valve according to the present invention (1), in which the pressing force is applied by screwing a male thread provided on an outer peripheral surface of the seat member into a female thread provided on an inner peripheral surface of the valve chamber.

In the present invention (2), because the pressing force is applied by a simple structure in which the male thread provided on the outer peripheral surface of the seat member is screwed into the female thread provided on the inner peripheral surface of the valve chamber, a cost reduction can be achieved.

A present invention (3) is the valve according to the present invention (1), in which the pressing force is applied by a seat member presser disposed below the seat member.

In the present invention (3), in a configuration in which the seat member and the valve main body are not fastened with a screw as in the present invention (2), the sealability can be maintained by applying a pressing force to the seat member using a seat member presser.

A present invention (4) is the valve according to the present invention (3), in which a male thread is provided on an outer periphery of the seat member presser, and the pressing force is applied by screwing the male thread into the female thread.

In the present invention (4), because the pressing force is applied by a simple structure for screwing the male thread provided on the outer periphery of the seat member presser into the female thread provided on the valve main body, a cost reduction can be achieved.

### Advantageous Effects of Invention

According to the present invention, it is possible to provide a valve for reducing the risk of leakage between a seat member and a valve main body when a high-temperature and high-pressure fluid is passed.

### BRIEF DESCRIPTION OF DRAWINGS

FIG. 1 is a partial cross-sectional view illustrating the entire valve according to an embodiment of the present invention.

FIG. 2 is a partial cross-sectional view illustrating a part of the valve illustrated in FIG. 1.

FIG. 3 is a perspective view of a seat member.

FIG. 4 is a schematic diagram illustrating comparisons in how the force is exerted and the like, between a conventional seat member and a seat member according to the present invention.

FIG. 5 is a partial cross-sectional view illustrating the entire conventional valve.

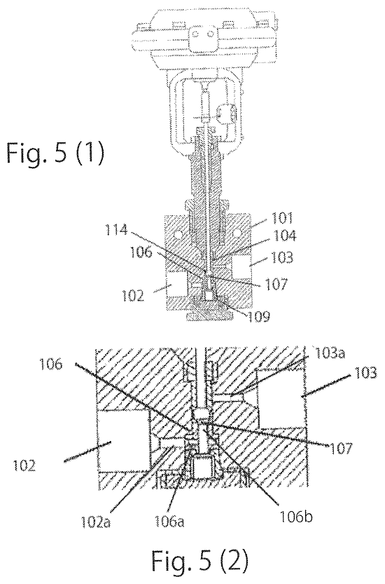

### DESCRIPTION OF EMBODIMENTS

An embodiment of the present invention will now be described in detail with reference to drawings. Note that the following embodiment is an essentially preferable example, and is not intended to limit the scope of the present invention, the applications or the use of the present invention in any way.

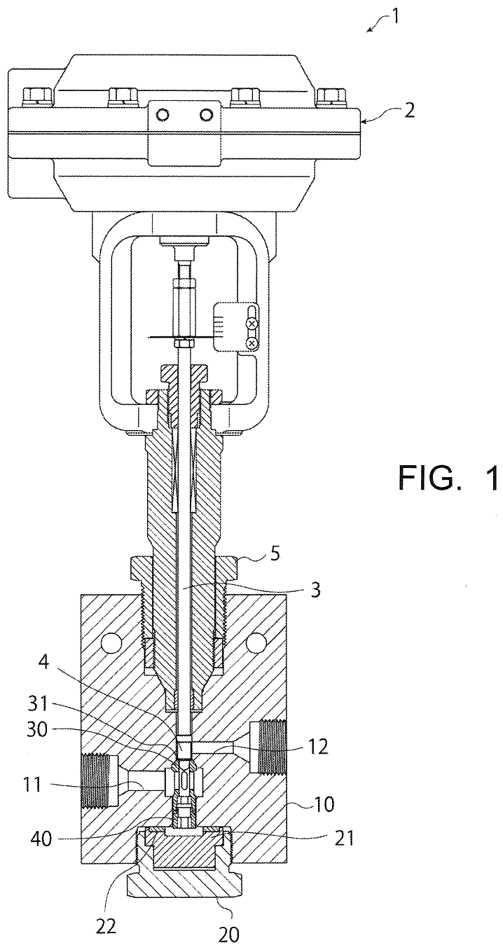

FIG. 1 is a partial cross-sectional view of the entire valve according to an embodiment of the present invention. A valve 1 controls the flow of a fluid by causing a valve body 4 attached to a distal end of a stem 3 that is connected to an actuator 2 to come into abutment against and to separate from a seat member 30 provided with a valve seat 31. The seat member 30 is disposed inside a valve main body 10 in which an inlet passage 11 and an outlet passage 12 are formed. The seat member 30 is required to have airtightness, wear resistance, thermal conductivity, and strength, and may be made of a general material such as carbon or metal. Disposed below the seat member 30 are a lid member 21 and a plug 20 for providing sealing using a tapered eccentric screw 40 and a gasket 22. The actuator 2 and the valve main body 10 are coupled to each other via a fixing screw 5.

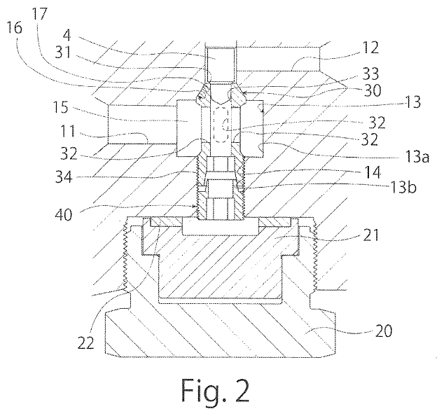

FIG. 2 is an enlarged view of a relevant part of the valve in FIG. 1. Some of the common description with that of FIG. 1 will be omitted. Inside the valve main body 10, a valve chamber 13 is provided, and a seat member 30 having a cylindrical shape is disposed inside the valve chamber. The valve chamber 13 has a large-diameter portion 13a and a small-diameter portion 13b. The large-diameter portion 13a is communicably connected to the inlet passage 11 via an opening provided to the inner peripheral surface thereof, and is communicably connected to the outlet passage 12 through an opening provided on the ceiling surface. The small-diameter portion 13b is provided with a female thread 14 on the inner peripheral surface thereof, and opens to the bottom surface of the valve main body 10. The seat member 30 is inserted from the bottom surface of the valve main body 10, and a male thread 34 provided to the outer periphery of a lower part of the seat member 30 is screwed into and fixed to the female thread 14. The male taper 35 formed on the upper end surface of the seat member is thus pressed against the female taper 16 provided on the ceiling surface of the large-diameter portion 13a, and provides sealing. The tapered eccentric screw 40 screwed into the female thread 14 is disposed below the seat member 30, and this tapered eccentric screw 40 prevents the seat member 30 from becoming loose. Below the tapered eccentric screw 40, the gasket 22 having an annular shape, the lid member 21, and the plug 20 are disposed, thereby providing sealing between the gasket 22 and the valve main body 10 so as to prevent the leakage to the outside from the bottom surface of the valve main body 10. The seat member 30 has an inlet-side communicating passage 32 that opens to the outer peripheral surface of the seat member 30 and is communicably connected to the inlet passage 11, and has an outlet-side communicating passage 33 that opens to the upper end of the seat member 30 and is communicably connected to the outlet passage 12. Around the periphery of the opening of the outlet-side communicating passage 33, a valve seat 31 is provided. In the embodiment illustrated in FIG. 2, the inlet-side communicating passage 32 has an oval shape elongated in the axial direction. Four of the inlet-side communicating passage 32 are provided in total, two opening on the left side and the right side, respectively, and two opening on the front side and the rear side, respectively, as indicated by a dotted line. The inlet-side communicating passage is thus provided with a structure enabled to handle a fluid at a high flow rate.

Between the inlet passage 11 and the inlet-side communicating passage 32, an annular space 15 is formed. The fluid flows in from the inlet passage 11, then circulates along the annular space 15 and passes through the four inlet-side communicating passages 32, passes through the outlet-side communicating passage 33, and flows out from the outlet passage 12.

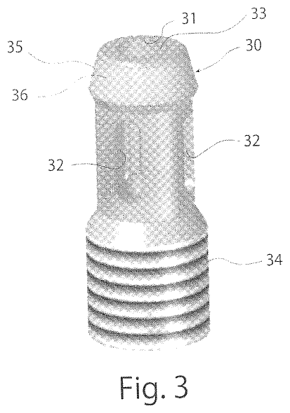

FIG. 3 is a perspective view of the seat member 30 used in the embodiment illustrated FIGS. 1 and 2. The outer peripheral surface of the lower part is provided with a male thread 34, and the male thread 34 is screwed into the female thread 14. The inlet-side communicating passage 32 is provided at the center, and the fluid passes through the inlet-side communicating passage 32, flows through the outlet-side communicating passage 33, and flows out from the outlet passage 12. On the upper end surface, the valve seat 31 is provided. The male taper 35 is provided on the outer periphery of an upper part of the seat member 30. A male taper abutting surface 36 comes into abutment with a female taper abutting surface 17 (see FIG. 2), and provides sealing.

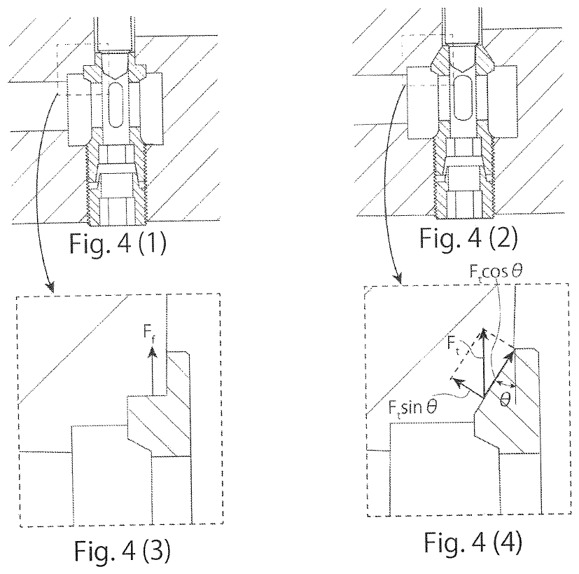

FIG. 4(1) is a partial cross-sectional view of a part of the valve chamber of a conventional valve, and FIG. 4(2) is a partial cross-sectional view of a part of the valve chamber of the valve according to the present disclosure. FIG. 4(3) is an enlarged view of the part surrounded by the dotted line in FIG. 4(1), and FIG. 4(4) is an enlarged view of the part surrounded by a dotted line in FIG. 4(2).

In FIG. 4(3) of the conventional valve, denoting the load exerted on the seal formed on the seat member as F_{f}, when the load F_{f} drops by δF_{f}, due to factors such as the loosened thread or the effect of a temperature change, this drop directly translates into a drop in the surface pressure of the seal surface by 100%.

By contrast, in FIG. 4(4) of the valve according to the present disclosure, denoting the load exerted on the seal formed on the seat member 30 as Fₜ, when the load Fₜ drops by δFₜ, the surface pressure only drops by an amount corresponding to the drop reduced by sinθ (where θ is a half angle of the taper). Denoting the static friction coefficient between the valve main body 10 and the seat member 30 as μ, the force corresponding to μFₜsinθ is exerted upward along the tapered surface, so that less force is required to maintain the seal between the seat member 30 and the valve main body 10, compared with that in the conventional structure.

### INDUSTRIAL APPLICABILITY

As described above, the valve according to the present invention can be used suitably as a valve that is less likely to experience leakage between the seat member and the valve main body when high-temperature and high-pressure fluid is to be passed.

### REFERENCE SIGNS LIST

1 valve
2 actuator
3 stem
4 valve body
5 fixing screw
10 valve main body
11 inlet passage
12 outlet passage
13 valve chamber
14 female thread
15 annular space
16 female taper
17 female taper abutting surface
20 plug body
21 lid member
22 gasket
30 seat member
31 valve seat
32 inlet-side communicating passage
33 outlet-side communicating passage
34 male thread
35 male taper
36 male taper abutting surface
40 tapered eccentric screw

1. A valve comprising:
a valve main body that includes a valve chamber communicably connecting an inlet passage and an outlet passage for a fluid;
a seat member that has a cylindrical shape, and that includes an inlet-side communicating passage communicably connected to the inlet passage, an outlet-side communicating passage communicably connected to the outlet passage, and a valve seat provided to a periphery of an opening of the outlet-side communicating passage, and that is disposed inside the valve chamber; and
a valve body that comes into abutment against and separates from the valve seat, wherein
a male taper is provided to a valve seat-side end of the seat member, and the male taper presses a female taper provided to the valve chamber to provide sealing.

2. The valve according to claim 1, wherein a female thread provided to an inner peripheral surface of the valve chamber and a male thread provided to an outer peripheral surface of the seat member are screwed with each other.

3. The valve according to claim 1, wherein a seat member presser is disposed on one end side of the seat member, the one end side being on an opposite side of the valve seat, and the seat member presser presses the seat member.

4. The valve according to claim 3, wherein the seat member presser and a female thread provided on an inner peripheral surface of the valve chamber are screwed with each other.
